(19) United States
(12) Patent Application Publication
(10) Pub. No.: US 2006/0034988 A1
(43) Pub. Date: Feb. 16, 2006

(54) Method for sheeting and processing dough

(76) Inventors: Steven Andrew Bresnahan, Plano, TX (US); Pravin Maganlal Desai, Carrollton, TX (US); John Mampra Mathew, Plano, TX (US); Holly Ann Nahrgang, Frisco, TX (US); Vamshidhar Puppala, McKinney, TX (US)

Correspondence Address: CARSTENS & CAHOON, LLP, P O BOX 802334, DALLAS, TX, 75380, US

(21) Appl. No.: 10/919,417

(22) Filed: Aug. 16, 2004

(51) Int. Cl. A21D 6/00

(52) U.S. Cl. 426/502

(57) ABSTRACT

An improved method to produce a dough sheet having improved uniform properties in a high-speed manufacturing environment. In accordance with one embodiment of the present invention, the dough sheeting system comprises improved control of dough particles in the sheeter nip, and improved control of dough properties across the width of the dough sheet including, but not limited to, uniform thickness, uniform work input, uniform moisture content, uniform emulsifier content, and uniform dry ingredient content. In a preferred embodiment, the improvements described herein enable the high-speed production of stackable chip products. Improved mixing and control of process conditions in dry and wet upstream mixers enable such production.

### BACKGROUND

1. Technical Field

The present invention relates to an improved method for processing dough to form a uniform continuous sheet. More specifically, this invention relates to the control of process equipment to form a sheet of dough of uniform thickness and uniform composition in high speed production.

2. Description of Related Art

Sheet Consistency

In a dough sheeting operation, there are many variables that can affect the rheology, uniformity, consistency, composition and dimensions of sheeted dough and of comestible product derived therefrom. The consistency of dough sheet characteristics depends upon several process conditions including, but not limited to, ingredient selection, relative amount of each ingredient, uniformity of ingredient concentration, moisture content, sheeter roller gap size (nip size), height of dough on sheeter rollers (nip dough height), energy absorbed by the sheeted dough (work input), and speed of sheeting rollers. One or more pairs of sheeting rollers may be used to produce a dough sheet. Each roller of each pair of rollers may turn at an independent speed.

Uniformity in mixing of ingredients can dramatically affect sheeting operations in high-speed dough production. Downstream processing (e.g. cutting, frying, packaging) and the final quality of comestible products (e.g. chips) are highly dependent on dough sheet properties being precisely controlled to specification. A dough sheet that is even slightly out of specification may result in ineffective chip cutting, chip sticking or erratic behavior in a fryer, and under- or over-frying. Further, dough sheets with non-uniform properties can present significant problems affecting fried product taste, texture, appearance, quality variability, and package weight variability. Dough uniformity can be measured both over time along the length of a dough sheet, and over the width of a dough sheet at a given position along its length. Precise control of dough development and sheeting process conditions is required to deliver raw chip pre-forms having a consistent composition, size and thickness, and to achieve a high quality finished product.

Precise control is especially important in the continuous stacked chip process. In a typical potato chip product, variations in chip weight, thickness and quality can be accommodated as chips of differing characteristics are mixed in a large container such as a bag. However, stacked chips must be mostly uniform in size, weight, thickness and quality as a fixed number of these chips are packed in a tube, can or canister. Each canister must weigh approximately the same, and must contain a fixed number of chips. Strict uniformity of a dough sheet is required for production of stacked chips.

Non-uniformity arises even before dough ingredients arrive at a dough sheeter. In mixers, as dry ingredients are mixed with one or more wet ingredients (e.g. emulsifiers, water), non-uniform mixing results in particles having excessive or insufficient amounts of one or more such ingredients. The relative concentration of one ingredient is often correlated to particle size. There is often a significant distribution of particle sizes leaving a typical wet mixer, which is evidence of non-uniform mixing of ingredients. Such non-uniform mixing results in defects in the finished product after dough is cut into a chip pre-form and cooked. A defect may be a hole or void, a discoloration, a chip of reduced size, a chip with a blister or bubble, or a chip of abnormal weight due to such non-uniform mixing of ingredients.

As a specific example of non-uniform mixing according to the prior art, dough particles of different sizes leaving a wet mixer often have significantly different amounts of emulsifier. FIG. 7 is a boxplot which shows the variability in the concentration of an emulsifier by weight percent in samples of dough particles collected after leaving a wet mixer and separated by sieves into six sizes 702, 704, 706, 708, 710, 712 according to the prior art. Referring to FIG. 7, samples on the left side are the largest 702 and the ones on the right side are the smallest 712. Particle sizes are shown on the horizontal axis and decrease from left to right. Emulsifier concentration is shown in weight percent on the vertical axis. Referring to FIG. 7, the median value of each set of samples is shown by a horizontal line 714 in each rectangle. The percentage of emulsifier in particles generally rises as particle size decreases.

Thus, variability in particle sizes leads to variability in composition of sheeted dough. Such variability arises because dough particles having differing concentrations of ingredients are not uniformly distributed across a dough particle conveyor leading to a dough sheeter. FIG. 7 shows the variability in composition of emulsifier in samples taken from the largest dough particles 702 of FIG. 7. These samples were taken from different regions of a dough conveyor before the dough particles have entered a sheeting apparatus according to the prior art. In FIG. 6, the samples taken from the center, left and right regions of the dough particle conveyor are represented by three boxplots (600, 602, and 604, respectively). Each boxplot is represented by a rectangle of a height of one standard deviation of the measured values of samples taken from each group. If the measured values from each group do not fall within such a rectangle, the entire range of measured values is represented by a line at the top and/or bottom of each rectangle. As in FIG. 6, the center line of each rectangle or boxplot in FIG. 6 is the median value 606, 608 and 610 of emulsifier for samples taken from each of the three regions of the dough particle conveyor. The median values from the samples from the left region 608 and right region 610 are nearly the same at a value of about 16% by weight. The median value 606 for the samples taken from the center region of the dough particle conveyor is about 21% by weight and is statistically different from the median values from the left 608 and right 610 regions. The difference in the median values measured from these regions shows that there is a need to control the overall distribution of emulsifier along the width of a dough particle conveyor before dough particles actually reach dough sheeting rollers. The need is to provide a uniform distribution of dough particles across the width of dough sheeter rollers such that the distribution of emulsifier across the width of a finished dough sheet is more uniform. Similarly, such need exists for other dough ingredients.

For example, according to the prior art, there is a variation of moisture according to variations in particle size. Larger particles leaving a wet mixer often have more moisture than smaller particles, the opposite of emulsifier. FIG. 3 shows a plot of the distribution of particle sizes according to weight percent for four batches 302, 304, 306, 308 of dough after leaving a wet mixer. Samples were collected and separated by mesh size. Mesh size is shown in units of millimeters on the horizontal axis while weight percent is shown on the vertical axis. Two batches 302, 304 were mixed with a high-speed Pavan mixer (Model Number P-PMP Model 1500, Pavan S.p.A., Galliera Veneta, Italy); two other batches 306, 308 were mixed with a Werner-Pfleiderer (WP) mixer (Model ZPM 240/3, Industrielle Backtechnik, Frankfurter Str. 17, D-7132 Tamm, Germany) In these four batches 302, 304, 306, 308, there is a relatively wide distribution of particle sizes.

Non-uniformity of ingredient distribution can be exacerbated at the time dough particles of different sizes are sheeted by a sheeting apparatus. FIG. 5 is a drawing of a typical dough sheeter. With reference to FIG. 5, dough particles 502 are brought to the top region of rollers 510, 514 by a roller-feeding conveyor 512, and mixed dough ingredients drop as pieces 502 onto a dough pile 504 atop the dough rollers 510. The dough rollers 510, 514 turn and compress dough particles 502 into a dough sheet 522. According to the prior art, chips cut from the peripheral regions 520 generally have a different composition and more variation in composition over time than chips cut from the center region 524 of sheeted dough 522. Chip defects become more common as particles of different sizes are allowed to migrate along the rollers 510, 514 of a dough sheeter. The resulting dough sheet has a non-uniform distribution of dough ingredients as measured along the width of the rollers 510, 514.

FIG. 13 illustrates and summarizes the need in the industry for improved mixing and sheeting by showing several typical composition profiles according to a typical distribution of particles spread across the width of sheeter rollers. With reference to FIG. 13, there typically are more dough particles piled up in the center region 1304 of sheeter rollers, and thus there is a larger weight percent 1312 of dough in the center region 1304. By having more particles in the center region 1304, dough particles are piled higher and the resulting dough sheet exiting the center region 1304 of the sheeter rollers has more work input per unit weight or volume than dough leaving the side regions 1302, 1306.

Further, as mentioned above, when dough is fed to a pair of rollers, larger particles tend to migrate toward the outside of the rollers. Thus, the sheeted dough toward the left side 1302 and right side 1306 exiting sheeting rollers typically have less moisture 1308, but more emulsifier 1310, per unit volume or weight than dough sheeted in the center region 1304.

Thus, a need exists to create a consistent, uniform distribution of particle sizes leaving dry and wet dough mixers. Further, a need exists to blend and sheet these dough particles of different sizes uniformly through, and across the width of, a dough sheeter such that the composition of the sheeted dough is uniform along its entire width and is uniform over time.

In high-speed production, as in a stackable chip process, there is an acute need for such a dough sheet having such improved characteristics. Such a dough sheet is required to provide a uniform weight of final product given the constraint of a fixed number of chips per container and a fixed total weight of product per container. Further, a more uniform dough sheet is needed to ensure product consistency among product containers.

Process Control

In the prior art, control instrumentation, processing methods, and automation have been developed and implemented for control of individual process conditions or variables affecting a dough sheet. For example, Spinelli, et al. (U.S. Pat. No. 4,849,234) describes a process to sheet dough at a constant mass flow rate by monitoring roller speed, tensile forces, and sheet thickness, and by making changes to one variable—roller speed—where the roller gap size is held constant. In another example, Ruhe, et al. (U.S. Pat. No. 5,470,599) discloses a thickness control system for high-speed production of tortillas having generally a uniform thickness. The invention described in Ruhe measures sheet thickness as the massa exits the roller and adjusts the nip size to create a tortilla of uniform thickness.

However, the prior art does not provide sufficient automatic, accurate and simultaneous control of certain process variables such as, but not limited to, ingredient feed rates, particle size variability, work input, sheet thickness, emulsifier concentration, moisture concentration, and particle size distribution before the particles are formed into a dough sheet. Such improved control is necessary to produce a uniform dough sheet meeting strict specifications. Such strict specifications are necessary to sustain high-speed production of stackable chips. The specifications can be measured over time at a given location relative to one end of a dough roller as the dough sheet exits the dough rollers, and can be measured across the width of such a dough sheet at any given point in time.

Specifically, and with reference to FIG. 5, a need exists to measure and evenly distribute dough particles 502 across the width of the rollers 510, 514. One advantage of such controlled distribution would be a more uniform nip dough height 516. A further need exists to control the work input absorbed by the dough sheet 522 leaving the rollers 510, 514. A further need exists to control roller speed over time in view of changes in other process conditions. A further need exists to automatically control process variables to compensate for variations in feed rate over time in order to produce a dough sheet to strict specifications. A need exists to make feed rate setpoint adjustments in order to produce a dough sheet meeting strict specifications. A further need exists to relate and control nip size 518 in accordance with variations in other process variables, such as, but not limited to, roller speed, feed rate, and feed composition. Strict control of nip size 518 is especially important in high speed production. Finally, a need exists to choose the relative amounts of dough ingredients which will allow for such strict control of process variables.

Dough Sheet Thickness Variability

Variability in sheet thickness according to the prior art hinders consistent and efficient high-speed production of dough for stacked chips and other food products. FIG. 7 shows two cross-sectional views of a dough sheet such as one 522 shown in FIG. 5 after it has been sheeted by sheeting rollers 510, 514. The transverse cross-sectional view in FIG. 7 is across the width of a dough sheet 522, in a direction parallel to dough rollers 510, 514. The longitudinal cross-sectional view in FIG. 7 is in a direction perpendicular to dough rollers 510, 514. Dough thickness irregularities 808 are partly responsible for variations in weight from chip to chip. Such variation can lead to undesirable variation in bulk density and container weight. Dough thickness variations 808 arise from variations in the composition of dough particles, nip dough height, roller speed, and other process conditions.

The horizontal, transverse cross-section of FIG. 7 shows the variability in final dough sheet thickness 528 in a dough sheet 810. Typically, final dough sheet thickness 528 is greater in the center of the dough sheet 804 than at its edges 806 because there is generally more dough particles piled at the center region of the nip of sheeter rollers. Variability in weight from container to container occurs because of this horizontal variability. Consequently, a need exists for a method to produce a dough sheet of uniform thickness in a longitudinal direction and in a horizontal direction along the width of sheeter rollers. Such a method would meet these criteria and could be used in a high-speed production environment.

### SUMMARY OF THE INVENTION

An improved high-speed dough sheeting method is disclosed which increases the consistency of the characteristics of sheeted dough. The method improves control of sheet thickness, moisture content, work input, uniformity of composition of dough ingredients of the sheeted dough, and uniformity of the height of dough in the sheeter nip. Such improvements are necessary for high-speed production of a stackable food product, especially with use of only one pair of sheeter rollers. The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is schematic diagram of a dough sheeting system according to one embodiment of the present invention;

FIG. 2 is a top side view of a conveyor showing pre-form chips aligned generally in rows and columns after exiting a cutting apparatus according to one embodiment of the present invention;

FIG. 3 is a plot showing the distribution of dough particle sizes, separated by mesh size, according to weight percent where two measurements are taken from each of two different mixers;

FIG. 4 is a side perspective drawing of a dough sheeting apparatus according to the present invention;

FIG. 5 is a side perspective drawing of a dough sheeting apparatus according to the prior art;

FIG. 6 is a graph showing the variability in composition of emulsifier in samples taken from different regions of a dough conveyor before dough particles enter a sheeting apparatus;

FIG. 7 is a graph showing emulsifier composition variations according to dough particles of different size;

FIG. 8a is a drawing of a longitudinal cross section of a sheet of dough according to the prior art;

FIG. 8b is a drawing of a transverse cross section of a sheet of dough according to the prior art;

FIG. 9 is a drawing showing dough particles after being mixed by a prior art mixer;

FIG. 10 is a drawing showing dough particles after being mixed by a Pavan mixer according to one embodiment of the present invention;

FIG. 11 is a graph showing the mean and one standard deviation of moisture content as measured from six batches of dough, three batches being mixed in a mixer according to one embodiment of the present invention, and three batches of dough being mixed in a prior art mixer;

FIG. 12a is a drawing showing a side view of an oscillating, moveable conveyor belt system used to more evenly distribute dough across the width of a conveyor as dough leaves a wet mixer and before reaching a dough sheeter;

FIG. 12b is a drawing showing a top side view of the system shown in FIG. 12a; and,

FIG. 13 is a drawing showing three profiles related to dough distributed across the width of sheeter rollers according to the prior art.

### REFERENCE NUMERALS

100 dry mixer
102 wet mixer
104 dough sheeter
106 cutting apparatus
108 sheeted dough forms
110 dry ingredients
112 emulsifiers
114 moisture
116 recycled dough
118 mixed dry ingredients
120 dough particles
122 dough sheet
124 scrap cutter
126 scrap dough particles
202 Chip pre-forms
204 columns
206 rows
208 conveyor belt
302, 304 dough particles from Pavan mixer
306, 308 dough particles from WP mixer
402 dough particles
404, 406 dough pile
408 height measuring element
410, 414 rollers
412 roller-feeding conveyor
416 nip dough height
418 nip size
432 exit conveyor
502 dough particles
504 dough pile
510, 514 rollers
512 roller-feeding conveyor
516 nip dough height
518 nip size
520 peripheral regions of dough sheet
522 dough sheet
524 center region of dough sheet
526 roller actuator
528 final dough sheet thickness
532 exit conveyor
600 boxplot of emulsifier concentration from center region
602 boxplot of emulsifier concentration from left region
604 boxplot of emulsifier concentration from right region
606 median value of 600
608 median value of 602
610 median value of 604
702 largest dough particles
704, 706, 708, 710 dough particles of decreasing size
712 smallest dough particles
714 median value of boxplots
804 center of dough sheet
806 edges of dough sheet
808 dough thickness irregularities
810 resulting dough sheet
900, 902, 904 batches of dough particles from WP mixer
1006 fluffy dough particles from Pavan mixer
1008 conveyor
1102, 1104, 1106 amount of moisture variation in dough from Pavan mixer
1108, 1110, 1112 amount of moisture variation in dough from WP mixer
1200 dough particles
1202 distal end of moveable conveyor
1204 oscillating mechanism
1206 moveable conveyor
1208 feeder conveyor
1210 bed of evenly distributed dough particles
1212 mechanical distributor system
1214 computer
1302 left region of sheeter rollers
1304 center region of sheeter rollers
1306 right region of sheeter rollers
1308 emulsifier
1310 moisture
1312 mass percent

### DETAILED DESCRIPTION

While the invention is described below with respect to a preferred embodiment, other embodiments are possible. The concepts disclosed herein apply equally to systems for producing sheeted material including dough. The production of dough is used as a preferred embodiment to illustrate the invention. Furthermore, the invention is not limited to use of the control devices described herein: other similar, obvious, or related devices or methods may be used in conformance with the spirit of the invention. Other process measurements, control methods, or control elements may be so substituted or combined and used with the present invention. In the illustrated embodiments, the various objects and layers are drawn at a scale suitable for illustration rather than at the scale of the actual material.

Dough Making Process

For a typical dough formulation, mixing hydrates the ingredients, develops the gluten and other proteins, and incorporates air into dough. Mixers are designed to push, pull, squeeze and knead the dough to achieve these functions. Sheeting machines also achieve these mixing functions. After mixing or sheeting, dough needs to be proofed wherein the dough relaxes to a point that represents the permanent structural modification of the dough due to mixing. Dough strength is a functional expression of gluten and other biochemical components, and depends on the amount of certain proteins present, and on the rate and amount of work input during mixing or sheeting. Proteins in dough must be both viscous and elastic, and the viscoelastic balance is critical. Finally, cooking dough completes the finished product.

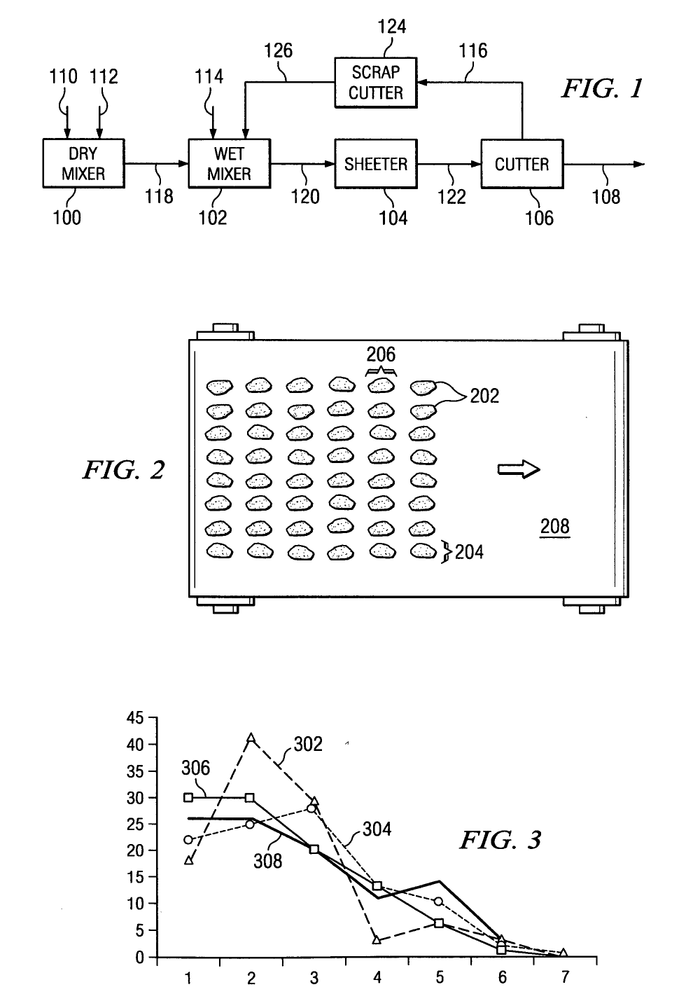

One embodiment of a dough sheeting process is represented schematically in FIG. 1. Referring to FIG. 1, dry ingredients 110 and emulsifiers 112 are fed into a dry mixer 100. The mixed dry ingredients 118 pass into a wet mixer 102 where moisture 114 is added to form dough particles 120. Next, dough particles 120 are compressed into a sheet 122 by a dough sheeter 104. The dough sheet 122 passes through a cutter 106 which forms the dough sheet 122 into final dough forms 108 such as chip pre-forms. Excess sheeted dough (known as recycle, re-grind or scrap) 116 from the cutter 106, is recycled and mixed with fresh dough in a wet mixer 102. Chip pre-forms 202 are shown in FIG. 2 exiting a cutter on a conveyor belt 208. Chips are generally aligned in both columns 204 and rows 206. Cooked chips are also aligned similarly on a conveyor after exiting a fryer and before being packaged. In one embodiment, a specific number of cooked chips are selected from one row 204 and packaged into a container.

Sheeted Dough Variability

In high-speed production of food product, such as stackable chips, mixing and sheeting require special care in order to yield a uniform dough sheet meeting strict requirements. Such a dough sheet is necessary in order to provide uniform weight of final product given a fixed number of chips per container, a fixed stack height per container, and given a fixed weight of product per container. Further, a more uniform dough sheet is needed to allow product consistency between containers over time and across the width of a dough sheet.

In the prior art, a relatively large variation from aim in dough sheet thickness or variation in dough weight per unit area is acceptable. The variation is greater in the art as the thickness of the dough sheet is smaller (e.g. a thickness less than one millimeter). However, in a preferred embodiment for the high-speed production of stackable chips, sheet thickness variability is maintained below about 3% of aim in dough sheet thickness and in dough weight variation with a root mean square of the error of such measurement less than or equal to about 3%. In one embodiment, such variability is maintained below about 1% of aim as measured over time. In another embodiment, the variability in dough thickness can be as much as 6% from aim as measured over time and over the width of the dough sheet. The improvements described in the present invention enable sufficient control of multiple process variables which enables production of a dough sheet meeting such strict variability of thickness at high speed. The improvements also enable the control of other process variables such as, but not limited to, work input, relative moisture content, and relative emulsifier content.

High-speed production is traditionally known to be production at a line speed of at least 90 linear feet of dough sheet produced per minute. However, the same techniques can be applied at various speeds, both faster and slower. High-speed production is considered to be as low as about 60 linear feet of dough sheet produced per minute.

There are many process conditions or variables that affect the consistency of the dough sheet as measured over time. Variation in a particular measured value is preferentially expressed as a percentage difference from the desired value, aim or setpoint of the particular measured value. Insufficient control of any of these variables results in unacceptable sheeted material and resulting undesirable product. In a preferred embodiment, a uniform sheet of dough is produced by reducing the disturbances in the following process variables:
relative amounts of dough ingredients,
particle size distribution exiting a dough mixer,
particle distribution over the width of sheeter rollers,
work input to the sheeted dough,
moisture distribution in dough particles,
emulsifier distribution in dough particles,
uniformity of mixing of scrap dough with fresh dough ingredients,
dough height above the nip of sheeter rollers, and
size of sheeter nip.
   Other embodiments are possible. The following explanation presents the details of the invention.
   Control of Dough Ingredients

Mass control loops reduce the variances in ingredient ratio and dough moisture content as measured over time. In this invention, variance can be measured as a percent deviation from the aim or setpoint of a desired process variable. Variance can also be measured in terms of a standard deviation from the mean, and in terms of a root mean square of the error (RMSE). In this invention, RMSE is defined as:
RMSE={square root over ((stdev²+(aim−mean)²)}
where “stdev” is the standard deviation of all the samples taken.

In one embodiment, a controller maintains the feed rate of potato flakes to a dry mixer at about 830 kg per hour (1830 lb per hour) with a root mean square of the error of 2.85 kg per hour (6.3 lb per hour). In this embodiment, a separate controller maintains the feed rate of emulsifiers and starch, combined into one stream, to the dry mixer at about 70 kg per hour (154 lb per hour) with a root mean square of the error of 0.49 kg per hour (1.08 lb per hour). In this embodiment, a separate controller maintains a water feed rate to a wet mixer at about 355 kg per hour (783 lb per hour) with a root mean square of the error of 0.42 kg per hour (0.93 lb per hour). A second controller trims the water feed rate with a second water stream at about 50 kg per hour (110 lb per hour) with a root mean square of the error of 0.18 kg per hour (0.40 lb per hour). This second trim controller measures dough moisture content and maintains the dough moisture at 35% with a root mean square of the error of 0.13%. These controllers provide continuous, strict control of dough ingredients thereby enabling the production of a dough sheet meeting strict consistency specifications. In another embodiment, a computer-based control mechanism provides that the relative amount of other dough ingredients fed to dough mixers is relatively constant over time.

The result is that the composition of dough particles exiting such mixers is relatively constant over time. The main sources of variability in the sheeting process after such control of individual feed streams is implemented are (1) the feed rate of dough particles fed to sheeter rollers, and (2) the inherent moisture content of each dough ingredient (e.g. relative amount of moisture in potato flakes). Dough sheet properties are strongly dependent on overall moisture content meaning the ratio of moisture to the other ingredients in the dough. The moisture content of dry dough ingredients may vary over time. For example, the moisture content of potato flakes fed to a dry mixer may not be uniform, which subsequently affects the overall moisture content of dough particles.

In one embodiment, and with reference to FIG. 1, dough ingredients enter a wet mixer 102 after leaving a dry mixer 100. Moisture content is measured after dough particles 120 leave a wet mixer 102 and before dough particles 120 are sheeted in a dough sheeter 104. Moisture content is measured with an Infra-red Engineering moisture gauge, model MM55 or 710 (NDC Infrared Engineering USA, Irwindale, Calif.). In another embodiment, variation in moisture content is determined by taking samples of dough particles or sheeted dough, and measuring moisture content off-line in a lab.

From such measurements, a human operator modifies the setpoint of a controller of the relative amount of moisture added to a wet mixer 102 in order to maintain a generally constant overall moisture content in finished sheeted dough 122. There is a delay or lag time between changing the amount of moisture and detecting the effect of such action. Such feedback control contributes to the production of a dough sheet having a more uniform thickness than previously possible.

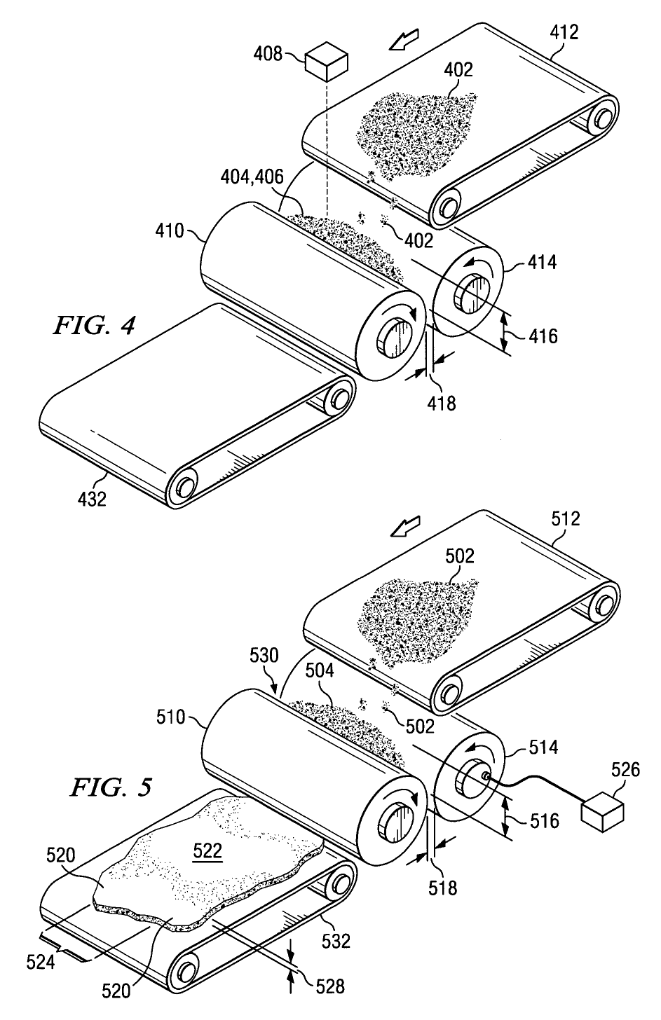

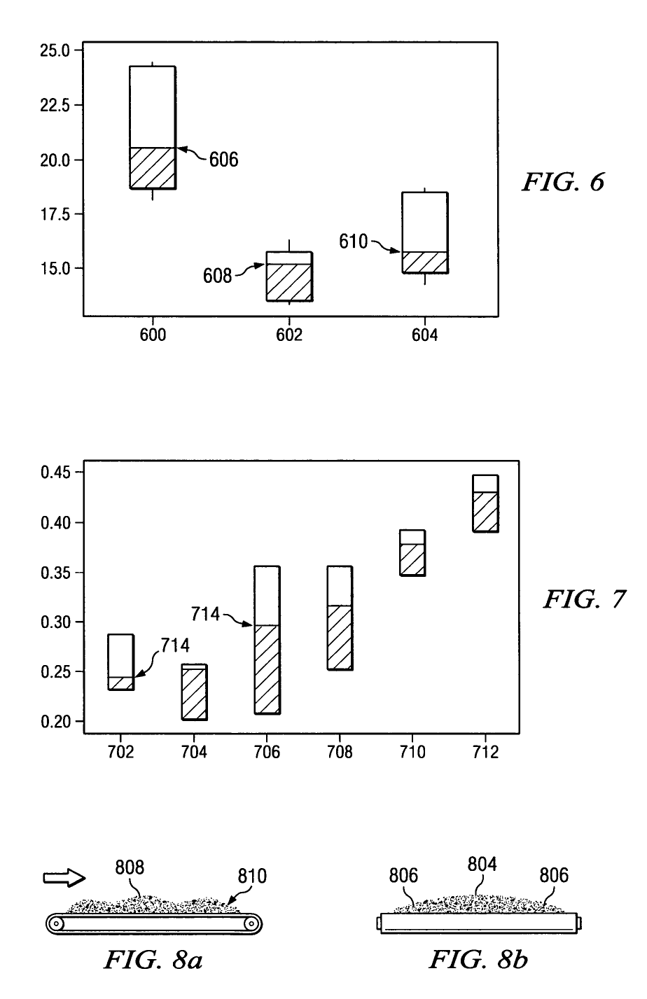

With reference to FIG. 1, in another embodiment, a moisture measurement signal is sent to a controller attached to an actuator 526 which automatically adjusts over time the amount of moisture 114 added to mixed dry ingredients 118 and scrap 116 in the wet mixer 102. Moisture 114 may be added continuously or batch-wise. With reference to FIG. 4, in other embodiments, a moisture measurement signal is used to control other process variables including, but not limited to, nip size 418, nip dough height 416, and work input.

Particle Size Distribution

The more uniform the distribution of dough particle size leaving a dough mixer, the more likely the sheeted dough will have consistent uniform composition and other characteristics. Table 1 shows the distribution of dough particle size according to weight percent.

TABLE 1
distribution of particle sizes

| Mesh Size (mm) → | 4 | 3.35 | 2.36 | 2 | 1.7 | 1.18 | 0.85 |
|---|---|---|---|---|---|---|---|
| Pavan Dough 1 | 18 | 41 | 29 | 3 | 6 | 3 | 0 |
| Pavan Dough 2 | 22 | 25 | 28 | 13 | 10 | 2 | 0 |
| WP Dough 1 | 30 | 30 | 20 | 13 | 6 | 1 | 0 |
| WP Dough 2 | 26 | 26 | 20 | 11 | 14 | 3 | 0 |

In a preferred embodiment, dough ingredients are mixed in a Pavan high-speed continuous dry pasta pre-mixer for several seconds; four to five seconds is usually a sufficient mixing duration. Such mixing differs from traditional mixing where mixing time is about one minute in duration. Even though mixed dough ingredients leave the high-speed mixer as dough particles of various sizes, the distribution of particle sizes measured over time is relatively constant.

Uniform, high-speed mixing produces dough particles that are considered fluffy, having a bulk density of about 27 pounds per cubic foot or less as compared to a typical bulk density of about 32 pounds per cubic foot produced from other dough mixers.

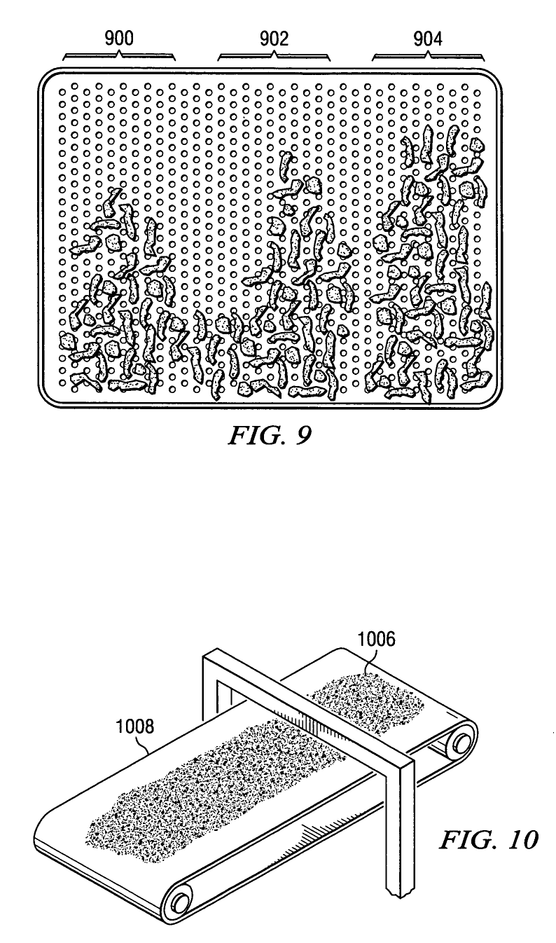

FIG. 9 shows three batches 900, 902, 904 of dough particles mixed with a Werner-Pfleiderer mixer. With reference to FIG. 9, disregarding the finest particles which fall through the screen, the dough particles shown are relatively large and non-uniform. FIG. 10 shows fluffy dough particles 1006 spread evenly on a conveyor 1008 after being mixed with a Pavan mixer. The dough particles mixed in a Pavan mixer 1006 are much more uniform in size, have a much different, fluffy appearance, and have a lower bulk density.

The dough particles with a lower bulk density facilitate a more level distribution of dough particles across the width of sheeter rollers. Such dough particles enable operation of sheeter rollers with a lower nip dough height such that less dough is piled above the nip at any given time. Further, such dough particles are required to produce a dough sheet having less work input per unit weight than previously available in the prior art, especially where only one set of rollers is used. Such fluffy dough particles also yield a dough sheet having a more consistent ingredient composition as measured over time and as measured over the width of the dough sheet. Such dough particles enable the production of a dough sheet meeting the strict requirements of high-speed production of stackable chips and other such food products.

Particle Distribution Across Sheeting Rollers

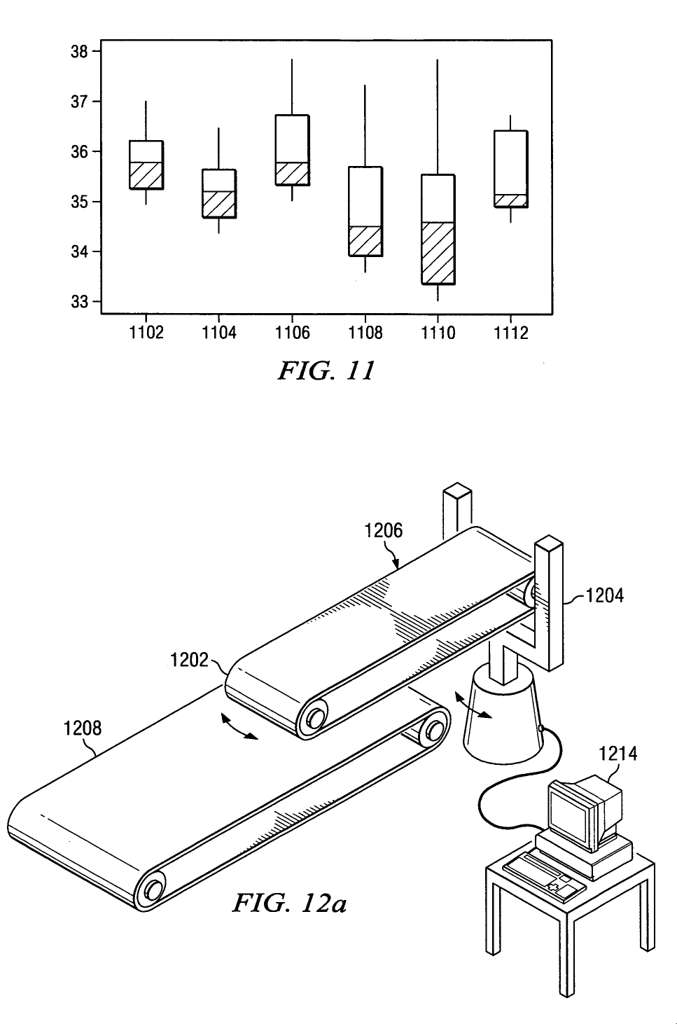

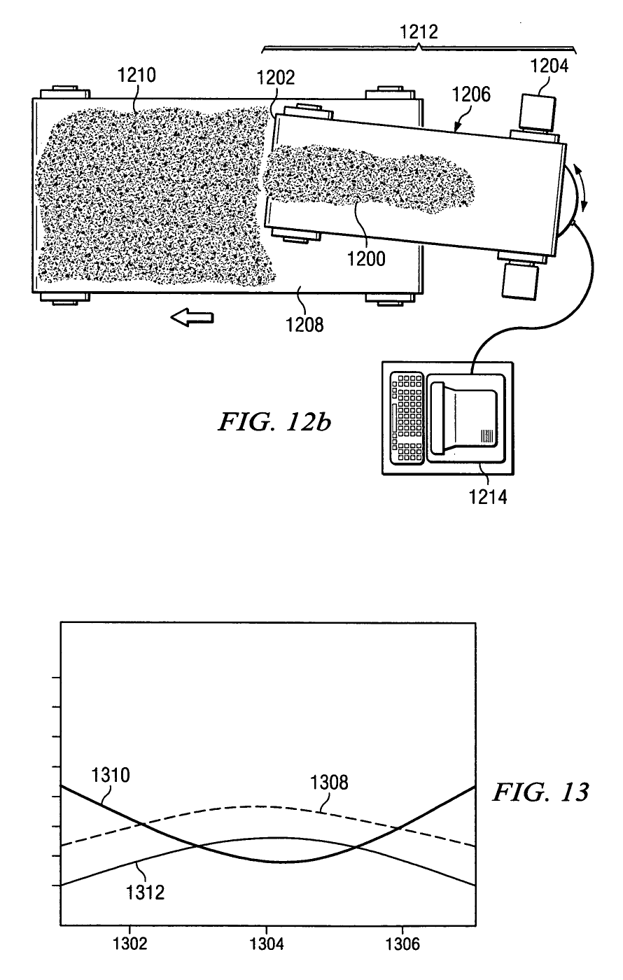

In another embodiment, and with reference to FIG. 12b, a mechanical distributor system 1212 more evenly distributes dough particles 1200 along a feeder conveyor 1208. A moveable conveyor 1206 transports dough particles 1200 to a roller-feeding conveyor, such as the one 412 shown in FIG. 4, which drops dough pieces above a roller nip area. The moveable conveyor 1206 physically oscillates from side to side through a mechanism 1204 which allows dough particles 1200 from a wet mixer to drop from a distal end 1202 of a moveable conveyor 1206 to a feeder conveyor 1208. The moveable or oscillating conveyor 1206 can be vertically hinged and attached to an upstream stationary object. Dough particles 1200 are more evenly spread across the entire width of a feeder conveyor 1208 forming a bed of evenly distributed dough particles 1210; such particles are more evenly distributed according to size than previously available in the prior art. Thus, dough particles feed or drop more evenly across sheeter rollers such as those 410, 414 shown in FIG. 4. FIG. 12a shows the moveable conveyor 1206 relative to a feeder conveyor 1208. The distance between the moveable conveyor 1206 and the feeder conveyor 1208 is chosen to maximally distribute the dough particles 1200 on the feeder conveyor 1208.

In a further embodiment, and with reference to FIG. 12b, the physical oscillating action of a moveable conveyor 1206 is controlled by a computer 1214. A computer 1214 may be composed of a digital programmable computer, an analog circuit, a digital circuit, or any combination thereof. The computer-controlled oscillating action results in a more uniform distribution of dough particles 1200 across the width of a feeding conveyor 1208.

Work Input

In a preferred embodiment, only one pair of sheeter rollers is used to produce a final dough sheet. In the prior art, use of multiple pairs of rollers is preferred to produce a final dough sheet having a desired work input. By using only one pair of sheeter rollers, however, significant capital expenses can be saved. The trade off, though, is that it is more difficult to produce a dough sheet having the same given work input. Similarly, by only using one pair of rollers, there is greater possibility of variability in work input as measured over time. By using only one pair of rollers, stricter control of other process variables is required to achieve the same work input. For example, dough particles must be of a more uniform size, and have a more uniform emulsifier and moisture content, before being sheeted through the single pair of sheeter rollers.

Different amounts of energy are required to mix flours having different characteristics in order to achieve a similar optimum dough quality. The relative amounts of other ingredients including moisture and emulsifiers affect the amount of work input required to generate a dough sheet of a given final thickness.

Work input can be estimated from mixer motor power, taking into account expected motor and drive chain losses, and from dough temperature rise measurements. The optimum degree of mixing and the optimum work input also can be determined from a torque measurement. With reference to FIG. 4, in a preferred embodiment, the work input per unit mass of dough is measured as a function of the power consumed in turning the sheeter rollers 410, 414 over time during the production of a dough sheet. The power measurement is logged and used by a human operator to adjust the set point of either nip dough height 416, nip size 418, or both.

Work is defined as the amount of power consumed over time. Work is also a force exerted over a distance. As the force on the dough particles increases, more energy is transferred to dough and the dough receives more work input. The amount of work input in the dough affects dough sheet rheology and cooking characteristics. For example, if work input is non-constant across the width of a dough sheet, different sections of the dough will react differently upon frying or use of another method of dehydration. If particular sections expand or contract to a greater degree than other sections due to variation in work input, deformities are more likely to occur.

Generally, the larger the nip dough height, the more work input dough particles receive. By having a shorter nip dough height, dough particles receive less work input. Also, having a shorter nip dough height allows for stricter control of work input over techniques used in the prior art. However, care must be taken to ensure sufficient dough material exists across the entire width of a pair of sheeter rollers as the dough particles are sheeted in order that the sheeter rollers are not starved resulting in gaps in the sheeted dough.

The amount of work input necessary to form a dough sheet of unit weight varies according to nip size, nip dough height, roller speed, relative moisture content of pre-rolled dough particles, and relative amount of other dough ingredients. With reference to FIG. 4, work input can be altered by changes in at least the following process parameters: roller speed, amount of energy or force used to turn the rollers 410, water content and emulsifier content of dough fed to the rollers 402, dough feed rate, nip size 418, nip dough height 416, and particle size distribution. Work input can vary over time at a given location of the dough sheet as the dough sheet exits a dough sheeter. Work input also can vary along the width of the sheeter rollers.

Work input varies strongly with nip dough height. By keeping the nip dough height at a generally constant value, the value of work input may be more tightly controlled than previously possible. By adjusting the nip dough height setpoint and the roller nip size setpoint, a desired amount of work input per unit weight or volume of dough is obtained.

The amount of work input absorbed by a dough sheet varies along the width of the sheet according to the nip dough height. If dough is piled higher in the center of dough rollers before being sheeted, the dough leaving the center of the rollers has a higher work input. Higher work input translates into finished chip products having undesirable properties or defects. Thus the dough nip height should be maintained evenly across the entire width of the sheeting rollers.

In one embodiment, the total work input absorbed by a dough sheet passing through one set of sheeter rollers is about 34.8 kJ per pound of dough (76.7 kJ per kg) with a root mean square of the error of about 0.34 kJ per pound of dough (0.74 kJ per kg). The work input is preferably between about 24 and 60 kJ per pound of dough (52.9 and 132 kJ per kilogram). However, a preferred embodiment maintains the work input and the variability of the work input to a minimum. In one embodiment, work input varies less than or equal to 1% from aim over time, and has a root mean square error less than or equal to 0.34 kJ per lb (0.74 kJ per kg) as measured over time. In another embodiment, work input varies as much as 6% as measured over time, and has a root mean square error as large as 3% as measured over time. In a further embodiment, work input varies as much as 6% as measured over the width of the dough sheet.

Moisture Distribution

In one embodiment, a Pavan high-speed continuous wet mixer is used to more consistently mix moisture with other dough ingredients. A Pavan mixer is preferred because in tests there was less variability in moisture content in dough samples as taken over time from such a mixer. In one embodiment, a Pavan wet mixer Model Number P-PMP Model 1500 operates at a speed of 800 to 1300 RPM with counter-rotating shafts or rotors. The speed is selected dependent on the dough ingredients such that the dough particles leaving the mixer have a desired bulk density and uniformity of size.

FIG. 11 is a boxplot showing the variability of moisture composition among samples taken from three batches of dough 1102, 1104, 1106 after each batch having been mixed according to the embodiment. The height of each rectangle represents one standard deviation. The lines above and below each rectangle represent the range of sample measurements recorded. FIG. 11 also shows the variability of moisture composition among samples taken from three batches of dough 1108, 1110, 1112 after each batch having been mixed in a Wemer-Pfleiderer mixer according to the prior art. The samples 1102, 1104, 1106 mixed in the Pavan mixer had less variability than those samples 1108, 1110, 1112 mixed in the WP mixer indicating that the Pavan mixer yields improved moisture consistency among sheeted dough particles. The use of the Pavan mixer is preferred because there is more consistent moisture content in the resulting dough sheet and individual finished chip pre-forms.

According to the same embodiment, there was substantial improvement in variation of moisture content between the largest and smallest particles of dough. The largest and smallest particles had a moisture weight percent of about 35.4% and 32.2%, respectively, with a variation of 3.2%. For comparison, the same relative amounts of ingredients were mixed in a Werner-Pfleiderer mixer, and the largest and smallest particles had a moisture weight percent of about 42.2% and 30.2%, respectively, a variation of 12%. The reduced variability achieved through improved mixing enhances the consistency of dough particles through the sheeting process and ultimately reduces the amount of defects in finished product. In a one embodiment, the moisture content in dough samples exiting a wet dough mixer varies by as much as about 3% from aim from one sample of dough particles to the next. In a preferred embodiment, the same moisture content varies less than about 1% from aim in sheeted dough as measured over time, and such moisture content has a root mean square of the error less than or equal to about 0.3% as measured over time. In another embodiment, the moisture content varies by as much as 3% over the width of the dough sheet.

Emulsifier Distribution

With reference to the prior art, in order to obtain a more uniform dough sheet, it is necessary to distribute emulsifier uniformly throughout the other dough ingredients. By heating and maintaining one or more liquid emulsifiers and other dough ingredients at a temperature above the melting point of all liquid emulsifiers, the dough ingredients leaving a dry mixer are in a preferred state to produce a dough sheet of more uniform composition. Heating of emulsifiers enables short mixing times. Short mixing times enable high speed production and enable efficient production of a sufficient quantity of dough particles for sheeting. In a preferred embodiment, a combination of paddles and cylindrical pins on the mixing shafts yielded optimal mixing of dough ingredients.

In another embodiment of the invention, a measurement of relative emulsifier content is taken from the sheeted dough. Subsequently, a signal is generated and sent to an actuator to adjust the relative amount of emulsifier added to the other dough ingredients in a mixer. By providing continuous, automatic feedback control of emulsifier, less variability in relative emulsifier content is obtained. In one embodiment, the variability of emulsifier in sheeted dough is maintained within 10% of aim as measured over time, and maintained with a root mean square of the error less than about 4% as measured over time. In another embodiment, the emulsifier content varies less than or equal to about 10% as measured over the width of the dough sheet. As the relative overall amount of emulsifier in a dough formulation is reduced, it becomes more difficult to maintain the variability of emulsifier at a relatively low value.

Uniform Mixing of Scrap

With reference to FIG. 1, in one embodiment, recycled dough 116 makes up about 30% of sheeted dough 122 taken from a cutting apparatus 106. Recycled dough 116 is that material which remains after uniform shapes are cut from a dough sheet. Recycled dough 116 is first reduced in size by a scrap cutter 124 before being transported and added as scrap dough particles 126 to fresh dough ingredients 114, 118 in a wet dough mixer 102. Recycled dough 116 is cut to such a degree that it resembles dough particles 1006 shown in FIG. 10. In one embodiment, recycled dough 116 is reduced to particles of about the same size as those dough particles leaving a wet mixer 102. In a preferred embodiment, the combination of recycled dough 116 and fresh dough ingredients 114, 118 resembles fluffy dough particles 1006 as shown in FIG. 10.

Dough Nip Height

FIG. 4 is a drawing of a side view of a dough sheeting apparatus. With reference to FIG. 4, dough particles 402 are fed to the top of sheeter rollers 410, 414 on a roller-feeding conveyor 412 where it is rolled through a gap or nip 430 of a certain size 418 between the sheeter rollers 410, 414. The height of dough piled atop the rollers 410, 414 or nip dough height 416 may be measured from the nip 430 between the rollers 410, 414 to the top of the pile of unsheeted dough particles 402. The nip dough height 416 may vary along the width of the rollers 410, 414. The dough sheet 422 leaves the nip 430 and is carried away by an exit conveyor 432. The final dough sheet thickness 428 may not be the same size 418 of the nip 430 at the time the dough passes through the sheeter nip 430, especially if dough particles 402 are only passed between one pair of sheeter rollers.

With reference to FIG. 4, final dough sheet thickness 428 depends on several process variables such as, but not limited to, overall feed rate, work input, roller speed, nip size 418, nip dough height 416, dough temperature, relative composition of each dough ingredient including moisture, providing sufficient dough to the roller, and inherent dough rheological properties (e.g. how dough deforms under stress). Final dough sheet thickness 428 is correlated most heavily to dough moisture content, nip dough height 416, and nip size 418. With reference to FIG. 5, final dough sheet thickness 428 also depends on the number of sheeter rollers used: the more rollers used, the closer the final dough sheet thickness 528 will match nip size 518.

With reference to FIG. 5, a set of prior art rollers such as that shown therein can be modified and controlled in accordance with the present invention to obtain sheeted dough with enhanced consistency over time and across its width. For example, in one embodiment, a signal (not shown) from a dough height detector is sent to an actuator (not shown) which varies roller speed in order to maintain nip dough height 516 at a generally constant value. In addition, a signal may also be sent to an actuator which controls nip size 518. By altering at least one of roller speed and nip size 518, a more uniform dough sheet is produced. In one embodiment, dough nip height 516 is maintained at or below about 115 mm (4.5 inches) over time with a root mean square of the error of 1.5 mm (0.059 inches). In another embodiment, dough nip height 516 is maintained at or below 80 mm (3.2 inches) over time.

In a preferred embodiment of the invention, and with reference to FIG. 4, a height measuring element 408 uses a laser (not labeled) to measure nip dough height 416. In the embodiment, a laser sensor or laser measuring device is manufactured by Micro-Epsilon, model ILD 1800-500 CCD. The laser has a long-range sensor, and a water-proof enclosure and signal cable. Care must be taken to ensure that falling dough particles do not interfere with the measurement and that falling dough particles 402 and local peaks are not mistaken for the average actual nip dough height 416.

In one embodiment of the invention, the raw measurement signal from a laser measuring device is filtered in two stages. First, the raw signal is aggregated over a short period of about 0.1 to 2.0 seconds. This aggregation eliminates the noise and false readings in the signal caused by dough particles falling through the laser and dough particles bouncing off of the sheeter rollers. Second, the aggregated signal is passed through a low-pass filter. This second filter reduces the high-frequency noise in the signal and produces a smoothed dough height measurement that is more accurately correlated with the actual nip dough height 416. Other embodiments of signal filtering are possible.

The laser sensor provides a measurement of improved accuracy over prior art measurements, and such measurement may be used to adjust other process conditions such as, but not limited to, the speed of the rollers 410, 414, dough feed rate, and nip size 418. In a preferred embodiment, nip dough height 416 is measured and controlled to a desired level by manipulating roller speed. In one embodiment, nip dough height 416 is maintained within 1% of aim and has a root mean square of the error of 1.0 mm. As disturbances enter the system, a change in the nip dough height 416 is automatically detected and corrected. By implementing the other improvements described in the current invention, the primary disturbances to nip dough height come from variations or fluctuations in overall feed rate of dough particles to the rollers, and variations in overall moisture content. For example, overall moisture content is affected by variations in the moisture content in potato flakes, one of several dry ingredients.

Sheeter Nip Size

In another embodiment, with reference to FIG. 4, a signal (not shown) may also be generated and sent to a roller actuator (not shown) which is attached to a dough roller 414 and physically moves this dough roller 414 relative to an opposing dough roller 410 thereby adjusting the nip size 418. The nip size 418 is adjusted over time such that the dough sheeter produces a dough sheet 422 of uniform thickness. Nip size 418 is adjusted based upon changes in process measurements, such as, but not limited to, a change in the relative moisture content of dough particles 402 fed to the dough sheeter, nip dough height 416, or the work input to the dough.

Final sheet thickness varies according to changes in nip size, nip dough height, relative moisture content of the pre-rolled dough particles, the relative amounts of other dough ingredients, and the number of pairs of sheeter rollers used to produce a final dough sheet. In one embodiment, referring to FIG. 4, nip size 418 is held constant while a measurement signal (not shown) from a laser nip dough height measuring element 408 is used to adjust the speed of at least one of the sheeter rollers 410, 414.

In another embodiment, a human operator measures the thickness of sheeted dough samples with calipers, and subsequently adjusts nip size to produce a dough sheet of desired thickness. Such an operator may also plot or trend the measured values over time after measuring sheet thickness. In another embodiment, sheet thickness is automatically measured, and a measurement signal is sent to a controller which subsequently adjusts nip size to produce a dough sheet of desired thickness.

Although the particle size distribution system and dough sheeter control system have been described with respect to one embodiment, these teachings also apply to other food items including any food products that are sheeted through the use of rollers. Other embodiments of such a distribution system may be used to distribute particles to more evenly distribute dough particles based on a characteristic other than size. Further, the process control system also applies to systems for sheeting food items where a strict specification is necessary such as in high speed production environments.

While the invention has been particularly shown and described with reference to a preferred embodiment, it will be understood by those skilled in the art that various changes in form and detail may be made therein without departing from the spirit and scope of the invention.

We claim:

1. A method for producing a comestible product sheet from a plurality of comestible product particles having a bulk density, said method comprising the steps of:
a) feeding said comestible product particles to a single pair of sheeting rollers having a nip size wherein said single pair of sheeting rollers comprises a first roller and a second roller, and further wherein said first roller has a rotational speed; and,
b) passing said comestible product particles between said rollers of step a) thereby making said product sheet wherein said product sheet has a sheet thickness, a work input, an emulsifier content, a moisture content, and a line speed, further wherein said line speed is at least 60 linear feet per minute, and further wherein said sheet thickness varies less than or equal to 6% from aim as measured over time.

2. The method of claim 1 wherein the bulk density is less than or equal to about 32 pounds per cubic foot (513 kg per cubic meter).

3. The method of claim 1 wherein the sheet thickness of step b) varies less than or equal to 3% from aim as measured over time.

4. The method of claim 1 wherein multiple measurements of said sheet thickness of step b) have a root mean square error less than or equal to 3% of the mean of said sheet thickness measurements.

5. The method of claim 1 wherein multiple measurements of said sheet thickness of step b) have a root mean square error less than or equal to 1% of the mean of said sheet thickness measurements.

6. The method of claim 1 wherein said sheet thickness of said product sheet of step b) varies less than or equal to 6% from aim over the width of said product sheet.

7. The method of claim 1 further wherein said work input of step b) is between about 24 and 60 kJ per pound of dough (52.9 and 132 kJ per kilogram).

8. The method of claim 1 wherein said work input of step b) varies less than or equal to 6% from aim as measured over time.

9. The method of claim 1 wherein said work input of step b) varies less than or equal to 3% from aim as measured over time.

10. The method of claim 1 wherein multiple measurements of said work input of step b) have a root mean square error less than or equal to 3% of the mean of said work input measurements.

11. The method of claim 1 wherein multiple measurements of said work input of step b) have a root mean square error less than or equal to 1% of the mean of said work input measurements.

12. The method of claim 1 wherein said work input of said product sheet of step b) varies less than or equal to 6% from aim over the width of said product sheet.

13. The method of claim 1 wherein said moisture content of step b) varies less than or equal to 3% from aim as measured over time.

14. The method of claim 1 wherein said moisture content of step b) varies less than or equal to 1% from aim as measured over time.

15. The method of claim 1 wherein multiple measurements of said moisture content of step b) have a root mean square error less than or equal to 3% of the mean of said moisture content measurements.

16. The method of claim 1 wherein multiple measurements of said moisture content of step b) have a root mean square error less than or equal to 0.3% of the mean of said moisture content measurements.

17. The method of claim 1 wherein said moisture content of said product sheet of step b) varies less than or equal to 3% from aim over the width of said product sheet.

18. The method of claim 1 wherein said emulsifier content of step b) varies less than or equal to 10% from aim as measured over time.

19. The method of claim 1 wherein multiple measurements of said emulsifier content of step b) have a root mean square error less than or equal to 4% of the mean of said emulsifier content measurements.

20. The method of claim 1 wherein said emulsifier content of said product sheet of step b) varies less than or equal to 10% from aim over the width of said product sheet.

21. The method of claim 1 further comprising the steps of:
c) generating a measurement of the thickness of said comestible product sheet; and,
d) adjusting said nip size of step a) in accordance with the measurement of step c).

22. The method of claim 21 wherein the measuring of step c) is performed by a human operator.

23. The method of claim 1 further comprising the steps of:
c) providing said comestible product particles to an oscillating spreader apparatus having at least one moving part; and,
d) controlling said oscillating apparatus to distribute said product particles generally evenly across the width of a conveyor prior to said particles being fed to said pair of sheeting rollers of step a).

24. The method of claim 23 further comprising the step of:
e) varying over time at least one of speed of said conveyor and oscillating speed of said spreader apparatus.

25. The method of claim 1 further comprising the steps of:
c) providing dough ingredients to a dry mixer;
d) mixing said dough ingredients of step c) in said dry mixer to form dry dough particles;
e) mixing said dry dough particles of step d) with moisture in a wet mixer such that the moisture content of comestible product particles exiting said wet mixer varies less than or equal to 3% from aim as measured over time.

26. The method of claim 1 further comprising the steps of:
c) providing dough ingredients to a dry mixer;
d) mixing said dough ingredients of step c) in said dry mixer to form dry dough particles;
e) mixing said dry dough particles of step d) with moisture in a wet mixer such that multiple measurements of moisture content of said comestible product particles exiting said wet mixer have a root mean square error less than or equal to 1% of the mean of said multiple moisture content measurements.

27. The method of claim 1 further comprising the steps of:
c) providing dough ingredients to a dry mixer;
d) heating at least one emulsifier;
e) adding said emulsifier of step d) to said dough ingredients of step c) in said dry mixer of step c);
f) mixing said emulsifier and said dough ingredients to form dry dough particles;
g) maintaining said dry dough particles above the melting temperature of said emulsifier of step d) until said dry dough particles reach a wet mixer; and,
h) mixing said dry dough particles with moisture in said wet mixer of step g) to form comestible product particles of step a).

28. A method for producing a comestible product sheet from comestible product particles said method comprising the steps of:
a) feeding said comestible product particles to a single pair of sheeting rollers having a nip and a nip size wherein said single pair of sheeting rollers comprises a first roller and a second roller, and further wherein said first roller has a rotational speed;
b) passing said comestible product particles between said rollers of step a) thereby making said product sheet wherein said product sheet has a sheet thickness, further wherein said line speed is at least 60 linear feet per minute, and further wherein said sheet thickness varies less than or equal to 6% from aim as measured over time;
c) sensing a nip dough height;
d) generating a signal indicative of said nip dough height of step c);
e) providing said signal of step d) to a system controller;
f) calculating a preferred value of said rotational speed of step a); and,
g) controlling at least one of said sheeting rollers of step a) in accordance with said preferred value of rotational speed of step f).

29. The method of claim 28 wherein the nip dough height of step c) is maintained under 130 mm (5.1 inches) along the width of said sheeting rollers of step a).

30. The method of claim 28 wherein the sensing of said nip dough height of step c) is by a laser measuring device.

31. The method of claim 28 wherein multiple measurements of nip dough height have a root mean square error less than or equal to 3% of the mean of said nip dough height measurements.

32. The method of claim 28 wherein said nip dough height varies less than or equal to 6% from aim as measured over time.

33. The method of claim 28 wherein said nip dough height varies less than or equal to 6% from aim over the width of said rollers of step a).
